(19) United States
(12) Patent Application Publication
(10) Pub. No.: US 2026/0216868 A1
(43) Pub. Date: Jul. 30, 2026

(54) DRIVE SYSTEM

(71) Applicant: Panasonic Intellectual Property Management Co., Ltd., Osaka (JP)

(72) Inventors: HIROTAKA UENO, Osaka (JP); YOSHIE YAMAMOTO, Osaka (JP)

(21) Appl. No.: 19/152,032

(22) PCT Filed: Jan. 26, 2024
(86) PCT No.: PCT/JP2024/002313

§ 371 Date: Jul. 30, 2025

(30) Foreign Application Priority Data
Feb. 22, 2023 (JP) 2023-026764

(51) Int. Cl. B25J 9/16; B25J 13/08

(52) U.S. Cl. CPC B25J 9/1633; B25J 9/1641; B25J 13/082

(57) ABSTRACT

Provided is a drive system capable of easily and smoothly suppressing vibration generated in a detection target. Drive system (1) includes: image processor (321) that processes an image from camera (21, 22) that captures at least a drive range of a driven member and extracts a detection target; vibration calculator (322) that calculates a vibration component of the detection target from a difference between a position of the detection target that has been extracted and a target position of the detection target; and control signal correction part (323) that corrects a control signal for driving the driven member with the vibration component, and suppresses vibration of the detection target.

### TECHNICAL FIELD

The present disclosure relates to a drive system that drives a driven member.

### BACKGROUND ART

Conventionally, a drive system that drives a driven member has been used in various fields. For example, an example of a drive system may include a robot hand that holds and transports an article. In this case, an arm or a hand of the robot hand, an article held by the hand, or the like serves as a driven member of the drive system. In addition, a processing device that transfers a light emitting part of laser light in one direction to cut a substrate or the like may be another example of the drive system. In this case, the light emitting part serves as a driven member of the drive system. In addition, an XYZθ stage that adjusts the position of the article placed on the stage may be an example of the drive system.

In these drive systems, the driven member is controlled to be driven to move to a predetermined target position. In this case, vibration generated in the driven member may be an obstacle to control.

For example, in the robot hand, the hand may be controlled to move at a high speed in order to transfer the article more quickly. However, in this control, a steep and large acceleration is applied to the hand at the start and end of the movement. Therefore, this acceleration may cause vibration in the hand. In addition, vibration from another drive system may be transmitted to the robot hand to cause vibration in the hand or the arm of the robot hand. Such vibration can be similarly generated in other drive systems other than the robot hand.

These vibrations may interfere with the control of the target to the driven member. For this reason, the drive system stops the driving of the driven member during the period where the vibration is generated, or performs control to suppress the vibration in parallel with the drive control of the driven member.

For example, PTL 1 below describes a robot control device which includes an acceleration sensor installed in a robot arm to suppress vibration of the robot arm. In this device, the difference between the motor speed of each axis obtained from a sensor signal of the acceleration sensor and the motor speed obtained from simulation is acquired as a vibration component. The acquired vibration component is fed back to the drive control of the motor, and the vibration generated in the robot arm is suppressed.

### CITATION LIST

### Patent Literature

PTL 1: Unexamined Japanese Patent Publication No. 2011-161562

### SUMMARY OF THE INVENTION

In the above method disclosed in PTL 1, it is necessary to individually install an acceleration sensor on a vibration detection target. However, when the detection target is extremely small, it is difficult to install the acceleration sensor on the detection target. In addition, when the detection target is an article itself transferred by the robot arm, the acceleration sensors need to be installed on all articles. Furthermore, it is necessary to re-attach the acceleration sensor every time the detection target changes. Such an operation is extremely complicated.

In view of such a problem, an object of the present disclosure is to provide a drive system capable of easily and smoothly suppressing vibration generated in a detection target.

A drive system according to a main aspect of the present disclosure includes: an image processor that processes an image obtained from a camera that captures at least a drive range of a driven member and extracts a detection target; a vibration calculator that calculates a vibration component of the detection target based on a difference between a position of the detection target that has been extracted and a target position of the detection target; and a control signal correction part that corrects a control signal for driving the driven member with the vibration component to suppress vibration of the detection target.

According to the drive system of the present aspect, it is possible to correct a control signal from an image of a camera and suppress vibration of a detection target without separately attaching an acceleration sensor or the like to the detection target of a driven member. In addition, since the image of the camera is used, the detection target can be set at any position of the driven member without limitation. Therefore, the vibration generated in the detection target can be easily and smoothly suppressed.

In the above description, the “detection target” is a portion of the driven member set as a target of vibration detection and suppression among the driven members driven by the drive system. For example, when the drive system is a robot arm, a part of the hand or a part of the arm of the robot arm, or an article held by the hand or a part thereof can be set as the “detection target”.

When a part to be a vibration detection target and a suppression target has a characteristic shape, and the part can be appropriately extracted by image processing, the “detection target” can be the part itself. On the other hand, when a part to be a vibration detection target and a suppression target does not have a characteristic shape, and it is difficult to accurately extract the part depending on image processing, for example, a marker separately attached to the part can be set as a “detection target”.

As described above, the drive system according to the present disclosure can provide the drive system that can easily and smoothly suppress the vibration generated in the detection target.

### BRIEF DESCRIPTION OF THE DRAWINGS

FIG. 1 is a side view illustrating a configuration of a drive system according to an exemplary embodiment.

FIG. 2 is a block diagram illustrating a configuration of a circuit portion of the drive system according to the exemplary embodiment.

FIG. 3 is a block diagram illustrating a configuration of a control device according to the exemplary embodiment.

FIG. 4A is a diagram illustrating calculation processing of a vibration component in a vibration calculator according to the exemplary embodiment.

FIG. 4B is a diagram illustrating calculation processing of a vibration component in the vibration calculator according to the exemplary embodiment.

FIG. 5 is a time chart illustrating a correction method of a control signal according to the exemplary embodiment.

FIG. 6 is a flowchart illustrating processing for suppressing vibration generated in a detection target according to the exemplary embodiment.

FIG. 7 is a flowchart illustrating correction processing of a control signal according to the exemplary embodiment.

FIG. 8 is a flowchart illustrating processing for suppressing vibration generated in a detection target according to a first modification.

FIG. 9 is a time chart illustrating an example of a vibration suppression operation according to the first modification.

FIG. 10 is a diagram illustrating a configuration of a drive system according to a second modification.

FIG. 11 is a block diagram illustrating a configuration of a circuit portion of the drive system according to the second modification.

### DESCRIPTION OF EMBODIMENT

Effects and significance of the invention according to the present disclosure will be more apparent from the following description of exemplary embodiments. However, the exemplary embodiments described below are merely examples for implementing the present invention, and the present disclosure is not limited to the exemplary embodiments described below.

Hereinafter, exemplary embodiments of the present disclosure will be described with reference to the drawings.

In the following exemplary embodiment, the present disclosure is applied to a drive system that drives a robot arm. In the robot arm, in addition to an arm and a hand, an article held by the hand corresponds to the driven member. In the following exemplary embodiment, a part of the article is set as a detection target. However, the present disclosure may not be limited to application in this type of drive system. The present disclosure can be applied to various drive systems that drive a driven member

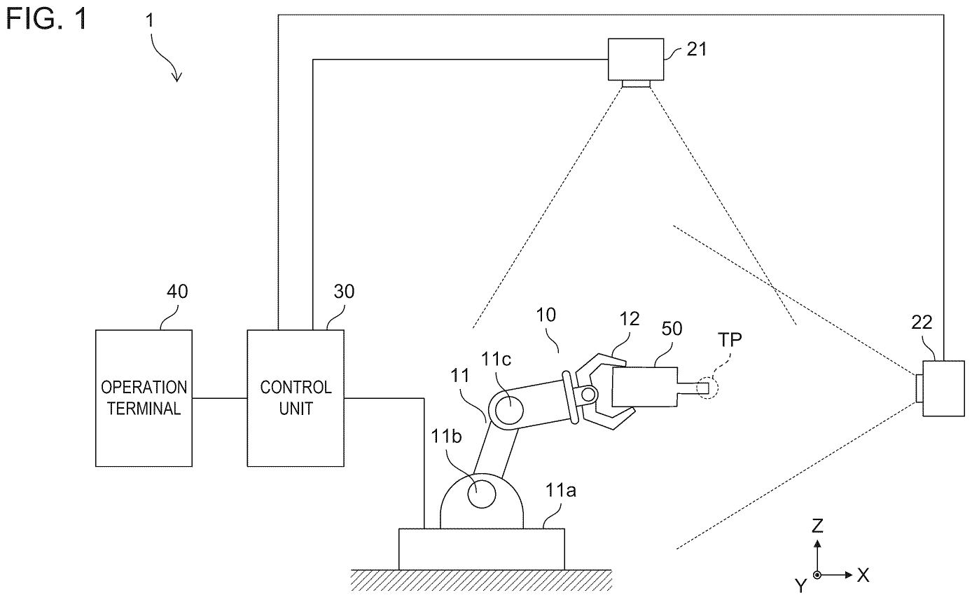

FIG. 1 is a side view illustrating a configuration of drive system 1. In FIG. 1, XYZ axes orthogonal to each other are added. A Z-axis positive direction is a vertically upper direction and is a height direction of robot arm 10.

Drive system 1 includes robot arm 10, cameras 21, 22, control unit 30, and operation terminal 40. Robot arm 10 is a driven member, grips article 50 (included in the driven member) at a transfer start position, and transfers the article 50 to a transfer end position. Robot arm 10 includes arm 11 and hand 12 each included in the driven member. Camera 21 is a two-dimensional camera including an imaging lens and an imaging element such as a charge coupled device (CCD). An imaging range of cameras 21, 22 includes at least an entire drive range of robot arm 10 (arm 11 and hand 12). One camera 21 is installed downward, and an optical axis of the imaging lens is substantially parallel to a vertical direction (Z-axis direction). Other camera 22 is installed sideways, and an optical axis of the imaging lens is substantially parallel to a horizontal direction (X-axis direction).

Control unit 30 controls robot arm 10 to transfer article 50 between the transfer start position and the transfer end position described above. The transfer start position and the transfer end position are set by a user via operation terminal 40. At this time, the user further sets a transfer route (transfer trajectory) of article 50 between the transfer start position and the transfer end position via operation terminal 40. Alternatively, operation terminal 40 may calculate and set an optimum transfer route (transfer trajectory) from the transfer start position and the transfer end position set by the user. The set transfer start position, transfer end position, and transfer trajectory are provided from operation terminal 40 to control unit 30. Control unit 30 controls robot arm 10 based on the provided information.

Robot arm 10 is a so-called articulated robot. Robot arm 10 includes arm 11 and hand 12. Arm 11 is rotated about a rotation axis parallel to the Z-axis by first drive part 11a installed on an installation surface (for example, the ground). FIG. 1 illustrates a state showing that arm 11 is parallel to an X-Z plane. Arm 11 can be rotated by second drive part 11b and third drive part 11c. In the state of FIG. 1, the rotation axes of second drive part 11b and third drive part 11c are parallel to the Y-axis.

Hand 12 is provided at a distal end of arm 11. Here, a configuration of hand 12 that grips article 50 by a plurality of claws is illustrated. Hand 12 may have a configuration that sucks article 50 by negative pressure to hold article 50 instead of the claws.

Two cameras 21, 22 are used to detect vibration in detection target TP. Here, detection target TP is set in a part of article 50. One camera 21 is used to detect vibration in the X-axis direction of detection target TP. Other camera 22 is used to detect vibration in the Y-axis direction and vibration in the Z-axis direction of detection target TP.

Control unit 30 processes the images from cameras 21, 22, extracts detection target TP, and calculates the vibration generated in the extracted detection target TP. Then, control unit 30 corrects a control signal for driving robot arm 10 to suppress the calculated vibration, and drives robot arm 10 by the corrected control signal.

Detection target TP is set by a user via operation terminal 40. The setting of detection target TP is performed by, for example, the following process.

Robot arm 10 holding article 50 is stopped in a predetermined posture. Images captured by cameras 21, 22 in this state are transmitted to operation terminal 40 via control unit 30. Operation terminal 40 displays these images. The user performs an operation of specifying a range of detection target TP on the displayed images. Operation terminal 40 transmits each image including a range of detection target TP specified by the user to control unit 30.

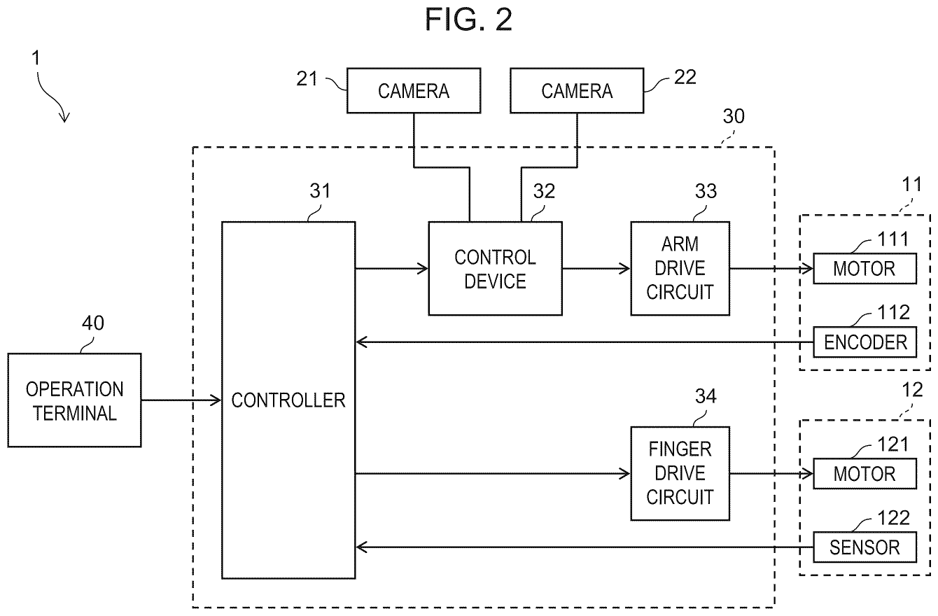

Control unit 30 stores these images, extracts an image near the range of detection target TP from these images, and stores the extracted image as a set image of detection target TP. At this time, control unit 30 associates information defining the static posture, that is, rotation amounts of first drive part 11a, second drive part 11b, and third drive part 11c (detection values of encoder 112 in FIG. 2) with the respective set images. The information may be acquired and stored for a plurality of static postures. Thus, the setting of detection target TP with respect to control unit 30 is completed.

During the actual operation, control unit 30 compares the image acquired from each of cameras 21, 22 with the set image for each of cameras 21, 22 stored in the above process, and extracts a range matching the corresponding set image on each image as detection target TP. Thereafter, control unit 30 calculates the vibration of extracted detection target TP, and corrects the control signal of robot arm 10 to suppress the vibration.

FIG. 2 is a block diagram illustrating a configuration of a circuit portion of drive system 1.

Arm 11 of robot arm 10 includes motor 111 and encoder 112. Although only one set of motor 111 and encoder 112 is illustrated in FIG. 2, actually, there are a plurality of sets of motor 111 and encoder 112 corresponding to first drive part 11a, second drive part 11b, and third drive part 11c in FIG. 1, respectively. Motor 111 drives the corresponding drive part with respect to the rotation axis, and encoder 112 outputs a detection signal corresponding to the rotation angle. Motor 111 is, for example, a stepping motor or an AC servo motor, and encoder 112 is a rotary encoder.

Hand 12 of robot arm 10 includes motor 121 and sensor 122. Motor 121 is a drive source for driving the claws of hand 12. Motor 121 is, for example, a stepping motor. Sensor 122 detects opening and closing of the claws in hand 12.

Control unit 30 includes controller 31, control device 32, arm drive circuit 33, and finger drive circuit 34 as a configuration of a circuit portion.

Controller 31 includes a microcomputer or the like, and controls each part of robot arm 10. Controller 31 controls arm 11 and hand 12 to execute control of transferring article 50 from the transfer start position to the transfer end position.

As described above, the transfer start position and the transfer end position of hand 12 and the transfer trajectory for transferring hand 12 from the transfer start position to the transfer end position are set in controller 31 via operation terminal 40. In the transfer process of hand 12, controller 31 detects a current position of hand 12 at every control timing of a constant cycle based on the detection signal output from encoder 112 of each drive part. Then, controller 31 generates a control signal to control the position of hand 12 to track the transfer trajectory, and outputs the generated control signal to control device 32 at the next control timing.

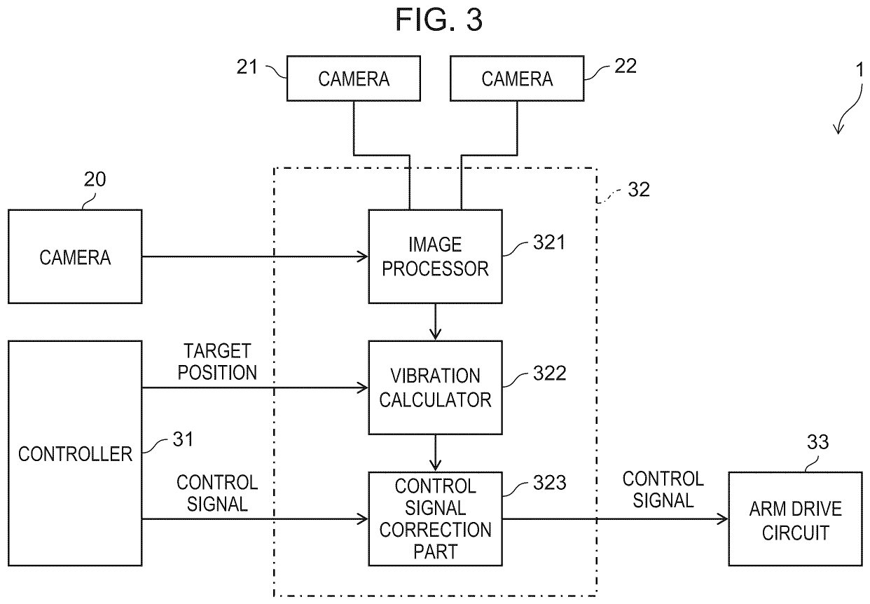

Control device 32 includes a microcomputer or a field programmable gate array (FPGA) and the like, and corrects a control signal input from controller 31 based on images from cameras 21, 22. In this correction, control device 32 detects the vibration of detection target TP from the images of cameras 21, 22, and corrects the control signal to suppress the detected vibration. The configuration and operation of control device 32 will be described later with reference to FIGS. 3 to 7.

Arm drive circuit 33 drives motor 111 based on a control signal input from control device 32 to drive arm 11. Finger drive circuit 34 drives motor 121 based on a control signal input from controller 31 to open and close the claws of hand 12. In the transfer start position, controller 31 outputs a control signal for gripping article 50 to finger drive circuit 34 while referring to the detection signal of sensor 122. In addition, controller 31 outputs a control signal for separating article 50 to finger drive circuit 34 while referring to the detection signal of sensor 122 at the transfer end position.

FIG. 3 is a block diagram illustrating a configuration of control device 32.

Control device 32 includes image processor 321, vibration calculator 322, and control signal correction part 323.

Image processor 321 acquires images from cameras 21, 22 at each control timing, performs analysis processing to each acquired image, and extracts detection target TP from each image. Image processor 321 outputs the extracted position of detection target TP on each image to vibration calculator 322.

Before acquiring the position of detection target TP from image processor 321, vibration calculator 322 acquires in advance a target position of detection target TP on each image at each control timing from controller 31.

That is, controller 31 calculates the transfer trajectory of detection target TP from the transfer trajectory of hand 12 and the positional relationship between hand 12 and detection target TP. Then, controller 31 specifies the position of detection target TP at each control timing on the transfer trajectory of detection target TP, and converts the specified position into a position on the images of cameras 21, 22. Controller 31 outputs the converted position to vibration calculator 322 as the target position of detection target TP of each control timing on each image.

Vibration calculator 322 calculates a difference between the position of detection target TP input from image processor 321 and the target position of detection target TP at the control timing as a vibration component of detection target TP.

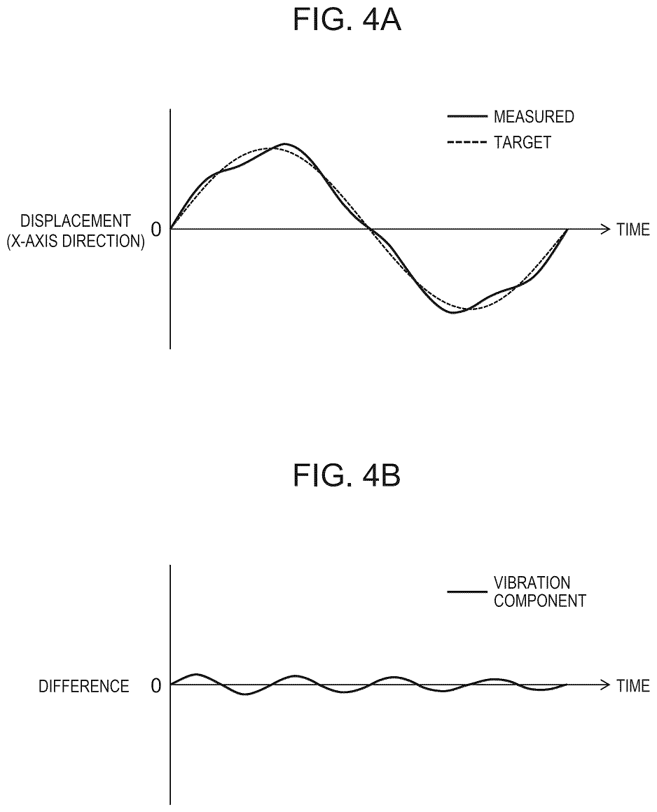

FIGS. 4A and 4B are diagrams illustrating calculation processing of the vibration component in vibration calculator 322. FIGS. 4A and 4B illustrate calculation processing of the vibration component in the X-axis direction using the image from camera 21.

A broken line in FIG. 4A indicates, as a waveform, a temporal change of a displacement component obtained by calculating the displacement component (displacement from the initial position) in the X-axis direction from a target transfer trajectory of detection target TP (target transfer trajectory on the image of camera 21). The target transfer trajectory is equivalent to a displacement component in the X-axis direction extracted from the transfer trajectory obtained by connecting the target positions of detection target TP on the image of camera 21 at each control timing supplied from controller 31 to vibration calculator 322.

A solid line in FIG. 4A indicates, as a waveform, a temporal change in the X-axis direction of the position of detection target TP obtained by calculating a displacement component (displacement from an initial position) in the X-axis direction of the position of detection target TP from detection target TP extracted from the image of camera 21 by image processor 321 at each control timing and connecting the calculated displacement components. A solid line in FIG. 4A indicates a waveform when vibration including a vibration component in the X-axis direction is generated in detection target TP.

As illustrated in FIG. 4A, when the vibration component in the X-axis direction is generated in detection target TP, the waveform (solid line) of the displacement in the X-axis direction of detection target TP extracted from the image of camera 21 vibrates according to the vibration component with respect to the waveform (broken line) of the target transfer trajectory of detection target TP. Therefore, the vibration component of detection target TP in the X-axis direction can be calculated by subtracting the waveform of the broken line from the waveform of the solid line.

FIG. 4B illustrates a waveform obtained by subtracting the displacement component of the waveform indicated by the broken line from the displacement component of the waveform indicated by the solid line in FIG. 4A.

As illustrated in FIG. 4B, the waveform of the vibration component in the X-axis direction of detection target TP can be obtained by subtracting the waveform of the broken line from the waveform of the solid line in FIG. 4A. Vibration calculator 322 in FIG. 3 calculates the vibration component in the X-axis direction at each control timing as described below. That is, the position in the X-axis direction is calculated with respect to the position of detection target TP in the image of camera 21 input from image processor 321. In addition, the position in the X-axis direction is calculated with respect to the target position of detection target TP on the image input from controller 31. Then, the vibration component in the X-axis direction at each control timing is calculated by subtracting the target position in the X-axis direction of detection target TP from the calculated position in the X-axis direction of detection target TP. As a result, a vibration component similar to the vibration component in FIG. 4B can be calculated.

Note that, although the method of calculating the vibration component in the X-axis direction in detection target TP has been described here, vibration components in the Y-axis direction and the Z-axis direction can be similarly calculated by performing similar processing on the image from other camera 22.

That is, vibration calculator 322 calculates the vibration component in the Y-axis direction at each control timing as described below. That is, the position in the Y-axis direction is calculated with respect to the position of detection target TP in the image of camera 22 input from image processor 321. In addition, the position in the Y-axis direction is calculated with respect to the target position of detection target TP on the image input from controller 31. The vibration component in the Y-axis direction at each control timing is calculated by subtracting the target position in the Y-axis direction of detection target TP from the calculated position in the Y-axis direction of detection target TP. Thus, the vibration component in the Y-axis direction of detection target TP can be calculated.

In addition, vibration calculator 322 calculates the vibration component in the Z-axis direction at each control timing as described below. That is, the position in the Z-axis direction is calculated with respect to the position of detection target TP in the image of camera 22 input from image processor 321. In addition, the position in the Z-axis direction is calculated with respect to the target position of detection target TP on the image input from controller 31. Then, the vibration component in the Z-axis direction at each control timing is calculated by subtracting the target position in the Z-axis direction of detection target TP from the calculated position in the Z-axis direction of detection target TP. Thus, the vibration component in the Z-axis direction of detection target TP can be calculated.

Returning to FIG. 3, vibration calculator 322 outputs the calculated vibration component of detection target TP in the X-axis direction, the Y-axis direction, and the Z-axis direction to control signal correction part 323. Control signal correction part 323 corrects the control signal input from controller 31 in order to suppress each vibration component based on the vibration component in each direction input from vibration calculator 322, and outputs the corrected control signal to arm drive circuit 33. Arm drive circuit 33 drives arm 11 by the corrected control signal. In this way, since arm 11 is driven by the corrected control signal, the vibration in detection target TP is suppressed.

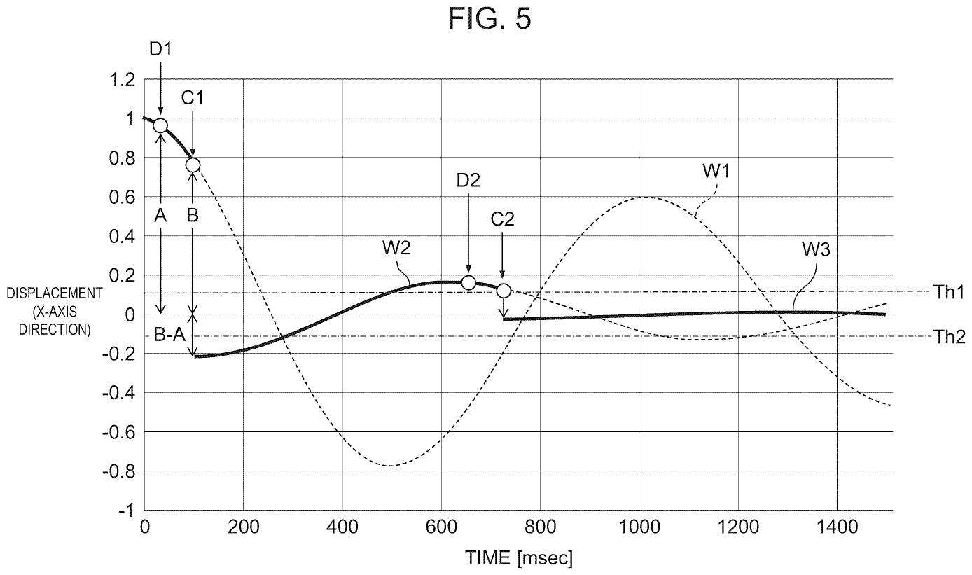

FIG. 5 is a time chart illustrating a control signal correction method.

The following correction method is suitable when the cycle of the vibration generated in detection target TP is several times or 10 times or more the cycle of the control timing. For example, when the vibration cycle of detection target TP is 100 ms, the cycle of the control timing is preferably equal to or less than 10 ms.

In the correction method of FIG. 5, the control timing near the peak of the change of the vibration component is determined. Then, the correction signal corresponding to the magnitude of the vibration component calculated by vibration calculator 322 at the determined control timing is superimposed on the control signal in opposite phase. This correction is executed when the magnitude of the vibration component exceeds the predetermined threshold range from Th1 to Th2. When the magnitude of the vibration component does not exceed the predetermined threshold range from Th1 to Th2, the above-described correction is not performed, and the control signal from controller 31 is supplied to arm drive circuit 33 as it is. The threshold range from Th1 to Th2 is set to have the same width in positive and negative directions based on zero.

FIG. 5 illustrates a correction method of the vibration component in the X-axis direction. Waveforms W1, W2, W3 in FIG. 5 indicate the temporal change of the vibration component in the X-axis direction of detection target TP extracted from the image of camera 21. Waveform W2 is a waveform of the vibration component that cannot be suppressed by the correction based on preceding waveform W1, and waveform W3 is a waveform of the vibration component that cannot be suppressed by the correction based on preceding waveform W2. Solid line portions of waveforms W1, W2 indicate waveforms of vibration generated before correction is performed, and broken line portions of waveforms W1, W2 indicate waveforms of vibration that continue when correction is not performed. Since waveform W3 is not corrected, it is indicated by a solid line.

In FIG. 5, it is determined that a peak has occurred in waveform W1 at control timing D1. The peak is determined, for example, by switching the increasing/decreasing direction of the displacement component in the X-axis direction.

That is, in the positive range of the displacement component, the control timing when the displacement component at the current control timing is shifted from the state where the displacement component at the current control timing is larger than the displacement component at the immediately preceding control timing to the state where the displacement component at the current control timing is smaller than the displacement component at the immediately preceding control timing is determined as the control timing when the peak occurs. In addition, in the negative range of the displacement component, the control timing when the displacement component at the current control timing is shifted from the state where the displacement component at the current control timing is smaller than the displacement component at the immediately preceding control timing to the state where the displacement component at the current control timing is larger than the displacement component at the immediately preceding control timing is determined as the control timing when the peak occurs.

In this way, when control timing DI where the peak occurs is determined, the correction signal for displacing arm 11 in the X-axis direction by the drive amount in the opposite phase for canceling vibration component A in the X-axis direction at control timing D1 is superimposed on the control signal (signal component in the X-axis direction of the control signal) from controller 31 at next control timing C1 that is the correction timing. As a result, vibration in the X-axis direction is suppressed at next control timing C1.

However, actual vibration component B in the X-axis direction at next control timing C1 is smaller than vibration component A. Therefore, at next control timing C1, correction may be performed excessively by difference B-A between vibration component A and vibration component B. As a result, vibration corresponding to new waveform W2 from control timing C1 can occur in detection target TP.

Also in this case, this vibration is suppressed by the similar processing as described above. Here, a peak is determined at control timing D2, and the correction signal is superimposed on the control signal at next control timing C2. This correction signal is a signal for displacing arm 11 in the X-axis direction by a drive amount of opposite phase for canceling the vibration component in the X-axis direction at control timing D2.

With this correction, the vibration of detection target TP is substantially converged as indicated in waveform W3, and the vibration of detection target TP in the X-axis direction falls within the threshold range from Th1 to Th2. Therefore, in a period until a new vibration exceeding the threshold range from Th1 to Th2 is generated in detection target TP, the vibration suppression processing in the X-axis direction, that is, the correction processing of control signal is not performed. In this way, the correction processing of the control signal for vibration in the X-axis direction ends.

With respect to the vibration in the Y-axis direction and the Z-axis direction, the control signal is corrected by the processing similar to the processing described above, and the vibration in these directions is suppressed.

That is, for the vibration in the Y-axis direction, the vertical axis in FIG. 5 is changed to the vibration component (displacement) in the Y-axis direction, and the control timing when the peak of the vibration component occurs is determined. Then, a correction signal for displacing arm 11 in the Y-axis direction by the drive amount of the opposite phase for canceling the vibration component at this control timing is superimposed on the control signal (the signal component in the Y-axis direction of the control signal) from controller 31 at the next control timing. This process is repeated until the vibration in the Y-axis direction falls within the threshold range from Th1 to Th2.

For the vibration in the Z-axis direction, the vertical axis in FIG. 5 is changed to the vibration component (displacement) in the Z-axis direction, and the control timing when the peak of the vibration component occurs is determined. Then, a correction signal for displacing arm 11 in the Z-axis direction by the drive amount of the opposite phase for canceling the vibration component at this control timing is superimposed on the control signal (the signal component in the Z-axis direction of the control signal) from controller 31 at the next control timing. This process is repeated until the vibration in the Z-axis direction falls within the threshold range from Th1 to Th2.

Thus, the vibration in each direction in detection target TP is suppressed.

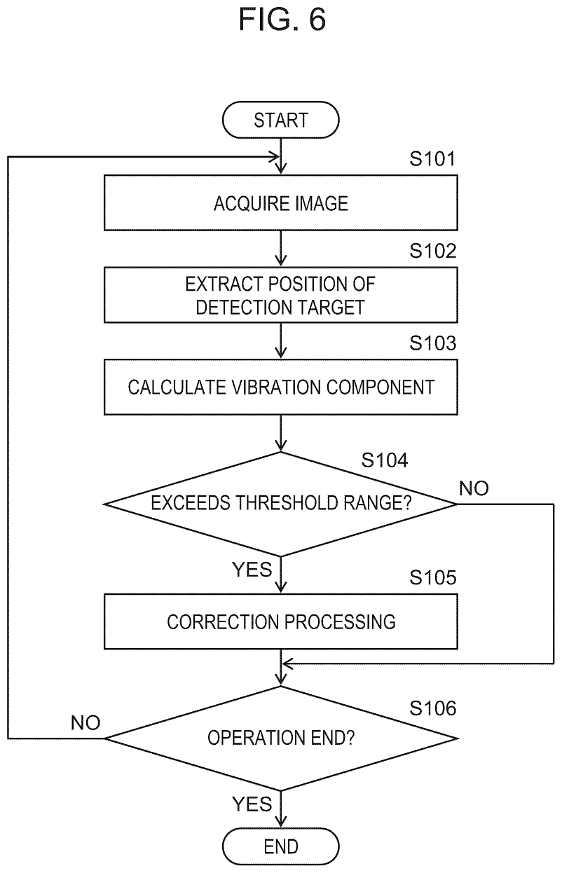

FIG. 6 is a flowchart illustrating processing for suppressing the vibration generated in detection target TP.

In the processing of FIG. 6, steps S101, S102 are performed by image processor 321, step S103 is performed by vibration calculator 322, and steps S104, S105 are performed by control signal correction part 323.

When the transfer operation is started, image processor 321 acquires the images from cameras 21, 22 at the current control timing (S101), and extracts the position of detection target TP from each acquired image (S102). Image processor 321 outputs the acquired position to vibration calculator 322.

Vibration calculator 322 calculates vibration components in the X-axis direction, the Y-axis direction, and the Z-axis direction of detection target TP by the processing illustrated in FIGS. 4A and 4B based on the input position of detection target TP on each image (S103). Vibration calculator 322 outputs the calculated vibration component in each direction to control signal correction part 323.

Control signal correction part 323 determines whether or not the vibration component in each direction that has been input exceeds the threshold range from Th1 to Th2 (S104). For the direction having the vibration component that exceeds the threshold range from Th1 to Th2 (S104: YES), control signal correction part 323 corrects the control signal from controller 31 by performing the correction processing for suppressing the vibration (S105), and for the direction having the vibration component that does not exceed the threshold range from Th1 to Th2 (S104: NO), control signal correction part 323 outputs the control signal from controller 31 as it is without performing the correction processing.

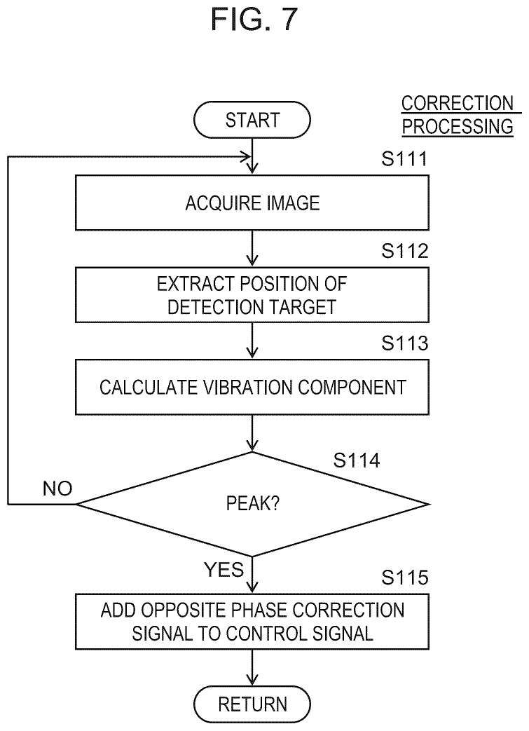

FIG. 7 is a flowchart illustrating correction processing performed in step S105 of FIG. 6.

Note that, in the processing of FIG. 7, at each control timing until step S114 becomes YES, the control signal from controller 31 is output as it is from control signal correction part 323 to arm drive circuit 33 without being corrected.

Image processor 321 acquires an image from a camera used for correction among the two cameras 21, 22 at the next control timing (S111). Image processor 321 extracts the position of detection target TP from the acquired image, and outputs the extracted position of detection target TP to vibration calculator 322 (S112). Vibration calculator 322 calculates a vibration component in the direction in which the correction is performed from the input position of detection target TP, and outputs the calculated vibration component to the control signal correction part 323 (S113).

Control signal correction part 323 determines whether the current control timing is the control timing when the vibration peaks by the processing in FIG. 5 (S114). When the determination in step S114 is NO, the processing in and after step S111 is repeated. Thereafter, when the determination in step S114 is YES, as illustrated in FIG. 5, control signal correction part 323 superimposes the correction signal of the drive amount of the opposite phase for canceling the vibration component in the direction at the current control timing on the control signal from controller 31 (S115). Control signal correction part 323 performs this processing for each direction being corrected. As a result, the correction processing of FIG. 7 ends.

Returning to FIG. 6, when the processing of step S105 ends in this way, each part of control device 32 repeatedly executes the processing of steps S101 to S105 until the transfer operation ends (S106: NO). Thereafter, when the transfer operation ends (S106: YES), each part of control device 32 ends the processing of FIG. 6.

### Effect of Eemplary Embodiment

According to the above-described exemplary embodiment, the following effects are exhibited.

As illustrated in FIG. 3, drive system 1 includes image processor 321, vibration calculator 322, and control signal correction part 323. Image processor 321 processes images from cameras 21, 22 that capture at least the drive range of the driven member (arm 11, hand 12, and article 50) and extracts detection target TP. Vibration calculator 322 calculates the vibration component of detection target TP from the difference between the extracted position of detection target TP and the target position of detection target TP. Control signal correction part 323 corrects the control signal for driving the driven member with the vibration component to suppress the vibration of detection target TP.

As a result, even if an acceleration sensor or the like is not separately attached to detection target TP of the driven member, the control signal can be corrected from the images of cameras 21, 22 to suppress the vibration of detection target TP. In addition, since the images of cameras 21, 22 are used, detection target TP can be set at any position of the driven member without limitation. Therefore, the vibration generated in detection target TP can be easily and smoothly suppressed.

As illustrated in FIGS. 5 and 6, control signal correction part 323 corrects the control signal from controller 31 when the vibration component exceeds the predetermined threshold range from Th1 to Th2, and outputs the control signal from controller 31 as it is without performing the correction when the vibration component does not exceed the threshold range from Th1 to Th2. As a result, the above-described correction is performed not by the vibration component but by the noise, and it is possible to suppress the occurrence of an undesirable operation in detection target TP. Therefore, the vibration generated in detection target TP can be stably suppressed.

As illustrated in FIG. 5, vibration calculator 322 calculates the vibration component at each control timing of a predetermined cycle, and control signal correction part 323 determines the control timing (D1, D2) near the peak of the change of the vibration component, superimposes a correction signal corresponding to the magnitude of vibration component A calculated at the determined control timing (D1, D2) on the control signal in opposite phase, and corrects the control signal.

In this way, by superimposing the correction signal corresponding to the magnitude of vibration component A near the peak in the opposite phase, the vibration energy of the driven member can be effectively canceled, and the vibration generated in detection target TP can be quickly and effectively attenuated. In addition, since the control timing (D1, D2) is near the peak, the polarity of the vibration component at the next control timing (C1, C2) is usually the same as the polarity of the vibration component at the control timing (D1, D2). Therefore, even if the correction signal having the opposite polarity of the vibration component acquired at the control timing (D1, D2) is superimposed on the control signal at the next control timing (C1, C2), the correction signal does not act to further increase the vibration. Therefore, the vibration of detection target TP can be stably suppressed.

As illustrated in FIG. 1, drive system 1 includes operation terminal 40 that receives an input from a user, and image processor 321 in FIG. 3 sets a portion of a driven member (arm 11, hand 12, and article 50) input via operation terminal 40 as detection target TP. As a result, the user can arbitrarily set a portion (detection target TP) where the user desires to suppress the vibration in view of the transfer operation, the contents of the article, and the like. Therefore, it is possible to cause drive system 1 to execute the vibration suppression control suitable for the transfer operation, the content of the article, and the like.

### First Modification

The exemplary embodiment of the present disclosure is not limited to the above, and various modifications are possible.

For example, in the above exemplary embodiment, the processing of FIGS. 6 and 7 is executed as the processing for suppressing vibration, but the processing for suppressing vibration is not limited to this processing.

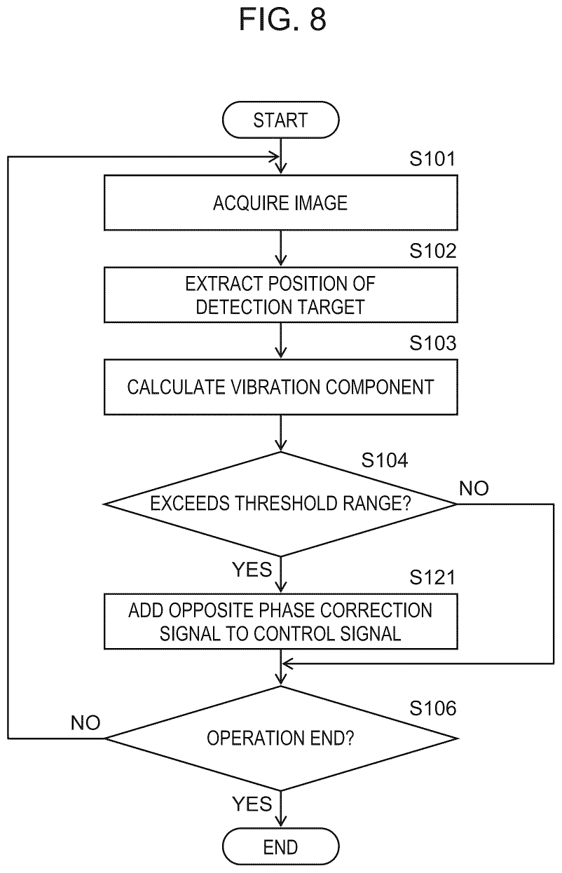

FIG. 8 is a flowchart illustrating a process for suppressing the vibration generated in detection target TP according to a first modification.

In the processing of FIG. 8, steps S101, S102 are performed by image processor 321, step S103 is performed by vibration calculator 322, and steps S104, S121 are performed by control signal correction part 323.

In the flowchart of FIG. 8, step S105 of the flowchart of FIG. 6 is changed to step S121. The processing of the other steps of the flowchart of FIG. 8 is similar to the processing of the corresponding steps of the flowchart of FIG. 6.

In the processing of FIG. 8, when the peak of the vibration component is not determined, and the vibration component exceeds the threshold range from Th1 to Th2 (S104: YES), the correction signal for driving arm 11 with the drive amount of the opposite phase that cancels the vibration component at the control timing is superimposed on the control signal from controller 31 at the next control timing (S121). That is, control signal correction part 323 corrects the control signal from controller 31 at each control timing when the vibration component exceeds the threshold range from Th1 to Th2.

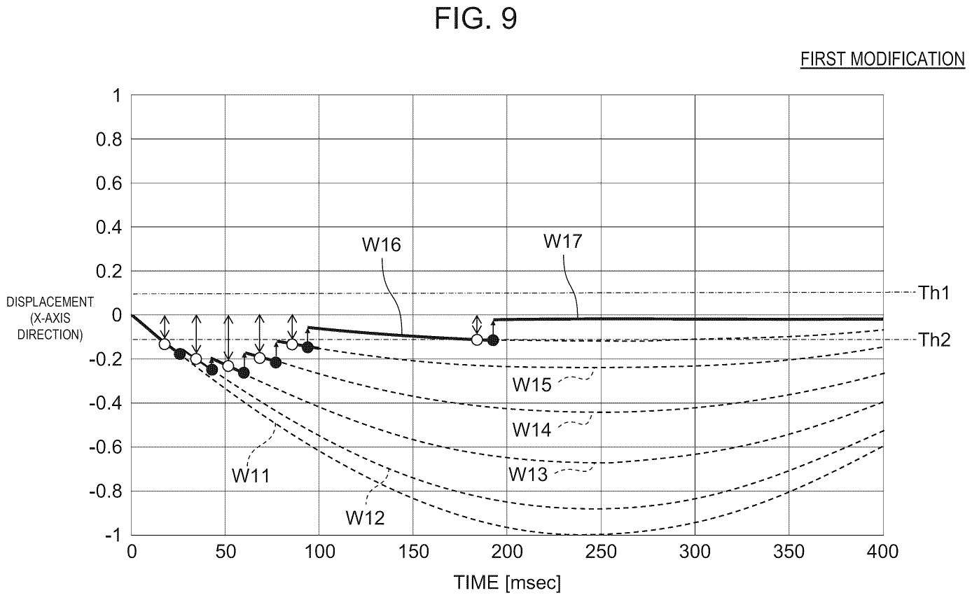

FIG. 9 is a time chart illustrating an example of the vibration suppression operation by the processing of FIG. 8.

Similarly to the case of FIG. 5, FIG. 9 illustrates a temporal change of the vibration component in the X-axis direction calculated from the image of camera 21. Here, seven waveforms of waveforms W11 to W17 are illustrated. Waveform Wn is a waveform of vibration that cannot be suppressed by correction with respect to waveform W(n−1). Note that n=11 to 17. As in the case of FIG. 5, in waveforms W11 to W17, a solid line portion indicates a waveform of vibration generated before correction is performed, and a broken line portion indicates a waveform of vibration that continues when correction is not performed. Since waveform W17 is not corrected, it is indicated by a solid line.

In FIG. 9, a white circle indicates a control timing when it is determined that the vibration component has exceeded the threshold range, and a black circle indicates a next control timing. However, in practice, the vibration component exceeds the threshold range also at the control timing of the black circle, but here, for convenience, the control timing of the black circle will be described as the control timing for correction. In practice, the control timing of the black circle is set to a control timing that exceeds the threshold range, the control timing of the white circle is set to a control timing for correction, and processing similar to the following is performed.

With respect to the vibration of waveform W11, the correction signal having the opposite phase of the magnitude corresponding to the vibration component (indicated by a double arrow) at the control timing of the white circle is superimposed on the control signal from controller 31 at the control timing of the black circle. As a result, the vibration component in the X-axis direction is suppressed as in waveform W12. However, since the correction amount of the correction signal in this case is a magnitude slightly exceeding the threshold range from Th1 to Th2, the vibration energy of the driven member cannot be greatly attenuated. Therefore, the amplitude of waveform W12 is only slightly smaller than the amplitude of waveform W11.

Thereafter, similarly, every time it is determined that the vibration component has exceeded the threshold range, the correction signal having the opposite phase corresponding to the magnitude of the vibration component at that time is superimposed on the control signal from controller 31 at the next control timing of the black circle. As a result, the vibration in the X-axis direction gradually attenuates, and the waveform of the vibration changes as waveforms W12 to W16. When waveform W16 is corrected in this manner, the vibration component in the X-axis direction converges in the range of the threshold range from Th1 to Th2 as in waveform W17. As a result, the suppression control of the vibration of detection target TP in the X-axis direction ends.

The vibration of detection target TP in the Y-axis direction and the Z-axis direction is gradually attenuated and converged to the threshold range from Th1 to Th2 by the similar control operation.

According to the control of the first modification, although the vibration of detection target TP cannot be effectively suppressed at one time as in the control illustrated in FIG. 5, the vibration can be gradually converged to the threshold range from Th1 to Th2 each time the vibration component exceeds the threshold. Therefore, the vibration of detection target TP can be quickly and smoothly suppressed, and the large vibration is not generated in the drive system.

### Second Modification

In the above exemplary embodiment, drive system 1 includes robot arm 10, but drive system 1 is not limited to this configuration.

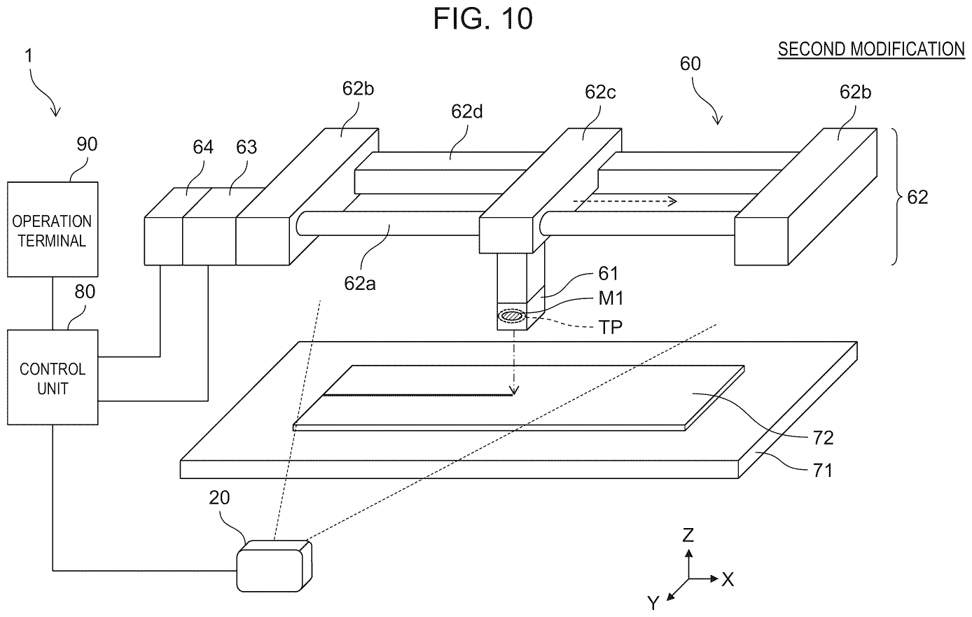

FIG. 10 is a diagram illustrating a configuration of drive system 1 according to the second modification. For convenience, X, Y, and Z axes orthogonal to each other are added to FIG. 10. The Z-axis positive direction is a height direction of processing device 60.

In the second modification, drive system 1 includes processing device 60 that cuts a substrate using laser light.

Processing device 60 includes laser unit 61, drive mechanism 62, motor 63, encoder 64, and installation part 71. Substrate 72 to be processed is installed on an upper surface of installation part 71. Processing device 60 transfers laser unit 61 in the X-axis direction to process substrate 72.

Drive mechanism 62 includes ball screw 62a, pair of fixing members 62b, movement member 62c, and guide rail 62d. Ball screw 62a is supported by the pair of fixing members 62b to be parallel to the X-axis. A bearing installed on movement member 62c meshes with ball screw 62a. Movement member 62c is slidably supported by guide rail 62d. Guide rail 62d is supported by the pair of fixing members 62b to be parallel to the X-axis.

Motor 63 is installed on one of the pair of fixing members 62b. The rotation axis of motor 63 is connected to one end of ball screw 62a. Encoder 64 is installed in motor 63. Encoder 64 detects a rotational position of motor 63.

Laser unit 61 is installed on a lower surface of movement member 62c. Laser unit 61 and movement member 62c are driven members. Laser unit 61 emits a laser beam having a predetermined wavelength downward (the Z-axis negative direction). When ball screw 62a is rotated by driving of motor 63, movement member 62c and laser unit 61 are transferred in the X-axis direction. At this time, by controlling the light emission of laser unit 61, substrate 72 on installation part 71 is processed by the laser light from laser unit 61.

Drive system 1 further includes camera 20, control unit 80, and operation terminal 90. The imaging range of camera 20 includes at least the entire drive range of the driven member (movement member 62c, laser unit 61) of processing device 60. Camera 20 is installed forward to set an optical axis of the imaging lens to be substantially parallel to the Y-axis. The control unit 80 is used to control processing device 60, and operation terminal 90 is used to perform a setting operation on control unit 80.

In the second modification, marker MI is attached to a front surface of laser unit 61, and marker M1 is detection target TP.

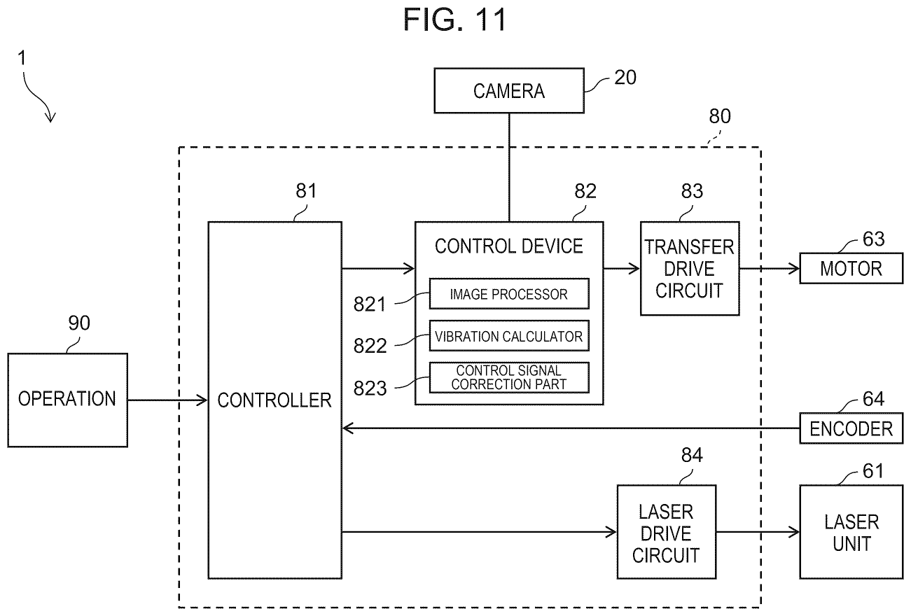

FIG. 11 is a block diagram illustrating a configuration of a circuit portion of drive system 1 according to the second modification.

Control unit 80 comprises controller 81, control device 82, transfer drive circuit 83 and laser drive circuit 84.

Controller 81 includes a microcomputer or the like, and controls each part of processing device 60. Controller 81 controls drive mechanism 62 to transfer laser unit 61 from a processing start position to a processing end position. In addition, controller 81 controls laser unit 61 to irradiate substrate 72 with a laser beam having an intensity according to processing.

Controller 81 detects a current position of laser unit 61 at each control timing of a predetermined period based on the detection signal output from encoder 64. Controller 81 then generates a control signal for controlling motor 63 to set the speed of laser unit 61 at each control timing to be a preset speed, and outputs the generated control signal to control device 82.

Control device 82 includes a microcomputer, an FPGA, or the like, and corrects a control signal input from controller 81 based on an image from camera 20. In this correction, control device 82 detects the vibration of detection target TP from the image of camera 20, and corrects the control signal to suppress the detected vibration.

Similarly to the above exemplary embodiment, control device 82 includes image processor 821, vibration calculator 822, and control signal correction part 823. The functions of image processor 821, vibration calculator 822, and control signal correction part 823 are similar to the functions of image processor 321, vibration calculator 322, and control signal correction part 323 in the above-described exemplary embodiment, except that there is one camera 20, that the vibration to be detected is only the vibration in the X-axis direction, and that the correction of the control signal is only the correction for the vibration in the X-axis direction.

That is, detection target TP is set in image processor 821 by the input to operation terminal 90. Image processor 821 extracts detection target TP from the image of camera 20 at each control timing, and outputs the position of the extracted detection target TP on the image to vibration calculator 822.

Vibration calculator 822 calculates a difference between the input position of detection target TP and the target position of detection target TP on the image at the detection timing input from controller 81 as a vibration component in the X-axis direction in detection target TP.

When the vibration component input from vibration calculator 822 exceeds the threshold range from Th1 to Th2, control signal correction part 823 executes the processing of FIG. 5, corrects the control signal input from controller 81, and outputs the corrected control signal to transfer drive circuit 83. When the vibration component input from vibration calculator 822 does not exceed the threshold range from Th1 to Th2, control signal correction part 823 outputs the control signal input from controller 81 to transfer drive circuit 83 as it is.

That is, the processing performed by control device 82 with respect to the vibration in the X-axis direction is similar to the processing in FIGS. 6 and 7. Alternatively, the processing of FIG. 8 illustrated in the first modification may be performed by control device 82 for the vibration in the X-axis direction. Here, a correction signal for accelerating or decelerating the movement of detection target TP to suppress the vibration component is superimposed on the control signal.

Transfer drive circuit 83 drives motor 63 in accordance with a control signal input from control device 82. As a result, laser unit 61 is transferred from the processing start position to the processing end position at a preset speed while vibration in the X-axis direction is suppressed. When the vibration is equal to or less than a predetermined threshold, laser drive circuit 84 drives laser unit 61 with the emission intensity according to the control from controller 81. In this way, laser unit 61 is transferred at a predetermined speed while laser unit 61 emits a laser beam having a predetermined intensity, and substrate 72 is processed.

Even in the second modification, similarly to the above exemplary embodiment, the control signal can be corrected from the image of camera 20 to suppress the vibration of detection target TP without separately attaching an acceleration sensor or the like to detection target TP of the driven member. In addition, since the image of camera 20 is used, the detection target can be set at any position of the driven member without limitation. Therefore, the vibration generated in detection target TP can be easily and smoothly suppressed.

### Other Modifications

In the above exemplary embodiment, in the processing of FIG. 5, the correction signal having the opposite phase of the magnitude corresponding to vibration component A at control timing D1 is superimposed on the control signal from controller 31 at next control timing C1. Alternatively, a correction signal having an opposite phase having a magnitude corresponding to vibration component A′ obtained by adjusting the amplitude of vibration component A at control timing D1 to be small by a predetermined ratio (for example, about several percent) may be superimposed on the control signal from controller 31 at next control timing C1.

Furthermore, in the processing of FIG. 9, a correction signal having an opposite phase having a magnitude corresponding to a vibration component obtained by largely adjusting the amplitude of the vibration component at the control timing of the white circle by a predetermined ratio (for example, about several percent) may be superimposed on the control signal from controller 31 at the control timing of the black circle.

Note that, in the processing of FIGS. 5 and 9, the threshold range from Th1 to Th2 may be set in advance in the device, or may be settable by the user via operation terminal 40. As described above, the threshold range from Th1 to Th2 may be set to suppress the execution of the correction processing not by the vibration component but by the noise.

In the processing of FIG. 5, the correction processing is not performed when the vibration component does not exceed the threshold range from Th1 to Th2. However, regardless of whether the vibration component exceeds the threshold range from Th1 to Th2, the correction processing of FIG. 5 may be performed in response to the determination of the peak of the vibration component. However, in this case, as described above, it is also conceivable that the correction processing is executed by noise instead of vibration. Therefore, in order to stably suppress vibration, it is preferable to perform the correction processing of FIG. 5 when the vibration component exceeds the threshold range from Th1 to Th2 as in the above-described exemplary embodiment.

In the above exemplary embodiment, the target position of detection target TP used in the vibration calculation processing of FIGS. 4A and 4B is calculated by controller 31 from the transfer trajectory of hand 12, but the method of acquiring the target position at each control timing is not limited thereto. That is, as long as the normal position of detection target TP at each control timing (the normal position when there is no vibration component) can be acquired as the target position, the target position may be acquired from parameter values other than the transfer trajectory of hand 12. For example, when the vibration component is not superimposed on the output from the encoder for detecting the rotation amount of each joint of robot arm 10, the target position of detection target TP at each control timing may be calculated based on the value output from the encoder at each control timing. In addition, the calculation of the target position may be performed by a circuit portion other than controller 31, such as control device 32, or may be performed by a dedicated circuit portion.

In the above exemplary embodiment, after the target position on the robot coordinate axis is converted into the position on the image of the camera, the difference between the converted target position and the position on the image of detection target TP input from image processor 321 is calculated as the vibration component. Conversely, the position on the image of detection target TP input from image processor 321 may be converted into the position on the robot coordinate axis, and the difference between the converted position and the target position input from controller 31 may be acquired as the vibration component.

The method for generating the control signal is not limited to the method described in the above exemplary embodiment or the second modification. For example, the control signal may be generated to extract the position of the predetermined reference part of the driven member from the images of cameras 21, 22, and control the extracted position to move to the target position along a predetermined movement trajectory.

Furthermore, in the above exemplary embodiment, the image processor, the vibration calculator, and the control signal correction part are individually described, but these two or all functions may be integrated into one. For example, the control signal correction part may have a function of a vibration calculator. In this case, the vibration calculator is omitted from the above configuration, and the position information from the image processor is input to the control signal correction part.

In addition, the number of cameras is not limited to the number described in the above exemplary embodiment and the first and second modifications, and three or more cameras may be used. Furthermore, the camera is not limited to a two-dimensional camera, and may be a three-dimensional camera capable of detecting a distance in an imaging direction.

The setting of detection target TP is not limited to the setting described in the above exemplary embodiment and the second modification, and another part of the driven member may be set as detection target TP. Furthermore, the application target of the technical idea of the present disclosure is not limited to the drive system having the configuration illustrated in the above-described exemplary embodiment and the second modification, and the technical idea of the present disclosure can be appropriately applied to drive systems having other configurations.

Various modifications can be made to the exemplary embodiments of the present disclosure as appropriate within the scope of the technical idea described in the claims.

### (Supplementary Note)

Techniques below are disclosed by the description of the above exemplary embodiment.

### (Technique 1)

A drive system including:
an image processor that processes an image obtained from a camera that captures at least a drive range of a driven member and extracts a detection target;
a vibration calculator that calculates a vibration component of the detection target based on a difference between a position of the detection target that has been extracted and a target position of the detection target; and
a control signal correction part that corrects a control signal for driving the driven member with the vibration component to suppress vibration of the detection target.

According to this technique, it is possible to correct the control signal from the image of the camera and suppress the vibration of the detection target without separately attaching an acceleration sensor or the like to the detection target of the driven member. In addition, since the image of the camera is used, the detection target can be set at any position of the driven member without limitation. Therefore, the vibration generated in the detection target can be easily and smoothly suppressed.

### (Technique 2)

The drive system according to technique 1, in which the control signal correction part performs the correction when the vibration component exceeds a predetermined threshold range, and outputs the control signal without performing the correction when the vibration component does not exceed the threshold range.

According to this technique, it is possible to suppress the occurrence of an undesirable operation in the detection target by performing the correction processing not by the vibration component but by the noise. Therefore, the vibration generated in the detection target can be stably suppressed.

### (Technique 3)

The drive system according to technique 1 or 2, in which
the vibration calculator calculates the vibration component at each control timing of a predetermined cycle, and
the control signal correction part performs the correction by determining the control timing near a peak of change of the vibration component, and superimposing a correction signal corresponding to a magnitude of the vibration component calculated at the control timing that has been determined on the control signal in opposite phase.

According to this technique, by superimposing the correction signal corresponding to the magnitude of the vibration component near the peak in the opposite phase, the vibration energy of the driven member can be effectively canceled, and the vibration generated in the detection target can be quickly and effectively attenuated. In addition, since the determined control timing is near the peak, the polarity of the vibration component at the next control timing is usually the same as the polarity of the vibration component at the determined control timing. Therefore, even if the correction signal having the opposite polarity of the vibration component acquired at the determined control timing is superimposed on the control signal at the next control timing, the correction signal does not act to further increase the vibration. Therefore, the vibration of the detection target can be stably suppressed.

### (Technique 4)

The drive system according to the technique 1 or 2, in which
the vibration calculator calculates the vibration component at each control timing of a predetermined cycle, and
the control signal correction part performs the correction at each of the control timings when the vibration component exceeds a predetermined threshold range.

According to this technique, although the vibration of the detection target cannot be effectively suppressed at one time, the vibration can be gradually converged to the threshold range every time the vibration component exceeds the threshold. Therefore, vibration of the detection target can be quickly and smoothly suppressed, and large vibration is not generated in the drive system.

### (Technique 5)

The drive system according to technique 4, in which
the control signal correction part superimposes a correction signal corresponding to a magnitude of the vibration component at the control timing when the vibration component exceeds the predetermined threshold range on the control signal in opposite phase, and performs the correction.

### (Technique 6)

The drive system according to any one of techniques 1 to 5, including an operation terminal that receives an input from a user,
in which the image processor sets a part of the driven member input via the operation terminal as the detection target.

According to this technique, the user can arbitrarily set a portion (a detection target) where the user desires to suppress vibration. Therefore, the drive system can be caused to execute the vibration suppression control suitable for the operation of the drive system.

### INDUSTRIAL APPLICABILITY

The drive system of the present disclosure can easily and smoothly suppress the vibration generated in the detection target. Therefore, controllability of the drive system is improved. As described above, the drive system of the present disclosure is industrially useful.

### REFERENCE MARKS IN THE DRAWINGS

1: drive system
11: arm (driven member)
12: hand (driven member)
20, 21, 22: camera
40, 90: operation terminal
50: article (driven member)
61: laser unit (driven member)
62c: movement member (driven member)
321, 821: image processor
322, 822: vibration calculator
323, 823: control signal correction part
TP: detection target
M1: marker

1. A drive system comprising:
an image processor that processes an image obtained from a camera that captures at least a drive range of a driven member and extracts a detection target from the image;
a vibration calculator that calculates a vibration component of the detection target based on a difference between a position of the detection target that has been extracted and a target position of the detection target; and
a control signal correction part that corrects a control signal for driving the driven member with the vibration component to suppress vibration of the detection target.

2. The drive system according to claim 1, wherein
the control signal correction part performs the correction when the vibration component exceeds a predetermined threshold range, and outputs the control signal without performing the correction when the vibration component does not exceed the predetermined threshold range.

3. The drive system according to claim 1, wherein
the vibration calculator calculates the vibration component at each control timing of a predetermined cycle, and
the control signal correction part performs the correction by determining the control timing near a peak of change of the vibration component, and superimposing a correction signal corresponding to a magnitude of the vibration component calculated at the control timing that has been determined on the control signal in opposite phase.

4. The drive system according to claim 1, wherein
the vibration calculator calculates the vibration component at each control timing of a predetermined cycle, and
the control signal correction part performs the correction at each of the control timings when the vibration component exceeds a predetermined threshold range.

5. The drive system according to claim 4, wherein
the control signal correction part superimposes a correction signal corresponding to a magnitude of the vibration component at the control timing when the vibration component exceeds the predetermined threshold range on the control signal in opposite phase, and performs the correction.

6. The drive system according to claim 1, comprising an operation terminal that receives an input from a user,
wherein the image processor sets a part of the driven member input via the operation terminal as the detection target.
